(19) United States
(12) Patent Application Publication
(10) Pub. No.: US 2003/0173519 A1
(43) Pub. Date: Sep. 18, 2003

(54) Pyroelectric sensor having reduced stray thermal coupling between its pixels

(76) Inventors: Andreas Seifert, St-Sulpice (CH); Paul Muralt, La Sarraz (CH)

Correspondence Address: SUGHRUE MION, PLLC, 2100 PENNSYLVANIA AVENUE, N.W., WASHINGTON, DC, 20037, US

(21) Appl. No.: 10/333,459

(22) PCT Filed: Jul. 6, 2001
(86) PCT No.: PCT/EP01/07498

(30) Foreign Application Priority Data
Aug. 4, 2000 (EP) 00116867.3

(51) Int. Cl. G01J 5/10

(52) U.S. Cl. 250/338.3

(57) ABSTRACT

The pyroelectric sensor includes a plurality of pixels (12A) each formed of a thin pyroelectric film (20A) and first and second electrodes (14, 28) arranged on either side of said film. The lower electrodes (28) are structured, i.e. they are micromachined so as to form electrodes belonging to the pixels so as to reduce the thermal cross-talk between the pixels. The pyroelectric film is porous. According to a preferred embodiment of the invention, the porous pyroelectric film is continuous and uniformly deposited on the sensor substrate. The porous films have reduced thermal conductivity, allowing sensors with a high level resolution to be obtained without requiring micromachining of the pyroelectric layer between the pixels.

The present invention concerns a pyroelectric sensor including a plurality of pixels arranged on a substrate and each formed of a thin pyroelectric film, of a first electrode of its own geometrically defining the pixel and a second electrode, these first and second electrodes being arranged respectively on both sides of the pyroelectric film.

Technology for manufacturing pyroelectric sensors in batches on a substrate, made, in particular, of silicon, with a thin pyroelectric film deposited by similar methods to that of semiconductor technology is relatively recent. Such technology enables relatively inexpensive pyroelectric sensors, able to be manufactured industrially in a large quantity, to be obtained. These sensors can be used particularly for gas spectrometry or thermal imaging.

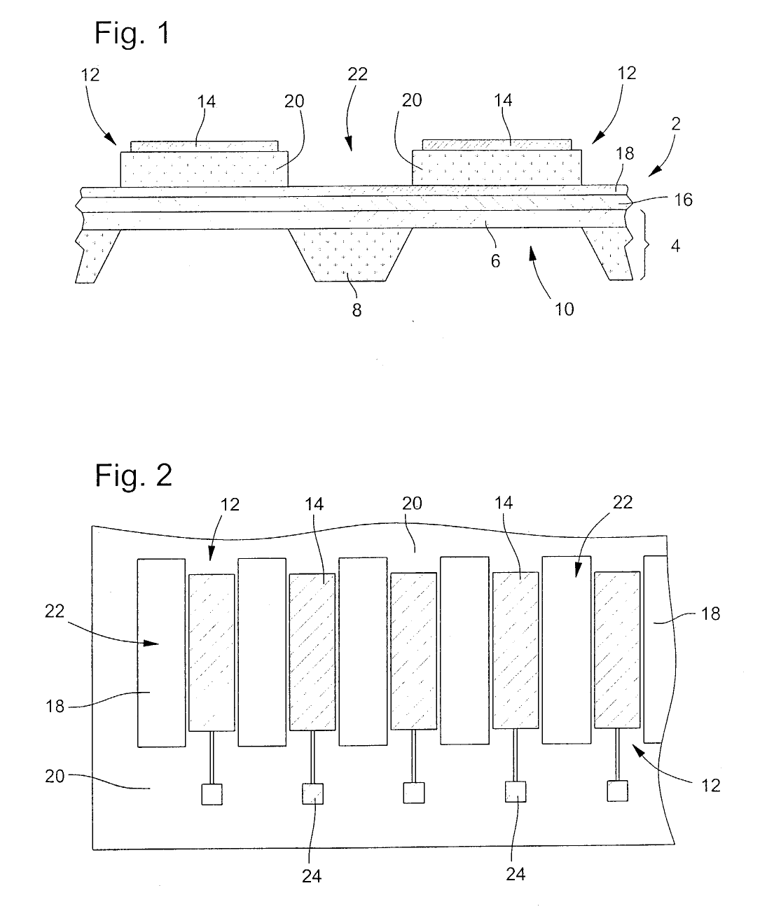

In the first developments of these sensors, those skilled in the art sought to minimise production costs while assuring that the manufactured sensors were of high quality. One factor affecting the efficiency of the sensor concerns the thermal cross-talk between the pixels, more particularly between adjacent pixels. In order to achieve the aforementioned dual objective, sensors like those shown in FIGS. 1 and 2 were initially made by the Applicant. FIG. 1 shows in cross-section two pixels of a sensor formed of a linear network of pixels like those shown in top view in FIG. 2.

Sensor 2 is formed of a substrate 4 with a top membrane 6 of small thickness and a silicon base plate 8 in which recesses 10 are micromachined at least underneath pixels 12 defined by the upper electrodes 14 of their own. On membrane 6 there is formed an adhesive film 16, on the upper surface of which is deposited a lower electrode 18 common to all the pixels. In order to avoid a step of micromachining conductive film 18, the latter is continuous over the entire surface of sensor 2. Between common electrode 18 and the electrodes 14 of their own there is deposited a thin pyroelectric film 20. This film 20 is micromachined so as to thermally insulate the pixels from each other. Recesses 22 are thus formed between the pixels of the linear network, these recesses having a rectangular profile when viewed from above. It will be noted that electrodes 14 are connected to contact pads 24 allowing elementary electric signals to be provided.

A first object of the present invention is to reduce the thermal cross-talk between the pixels. A second object of the invention is to reduce the production costs of thin films of pyroelectric sensors. A third object of the invention consists in finding an optimum between the two aforementioned objects, i.e. obtaining a sensor having a high resolution level as regards the pixels and a relatively low manufacturing cost.

These aforementioned objects are achieved by the subject matter according to claim 1.

The invention will be explained and its advantages described hereinafter using the following description, made with reference to the annexed drawings, given by way of non-limiting examples, in which

FIGS. 1 and 2, already described, are respectively partial cross-section and top views of a pyroelectric sensor initially developed by the Applicant, and

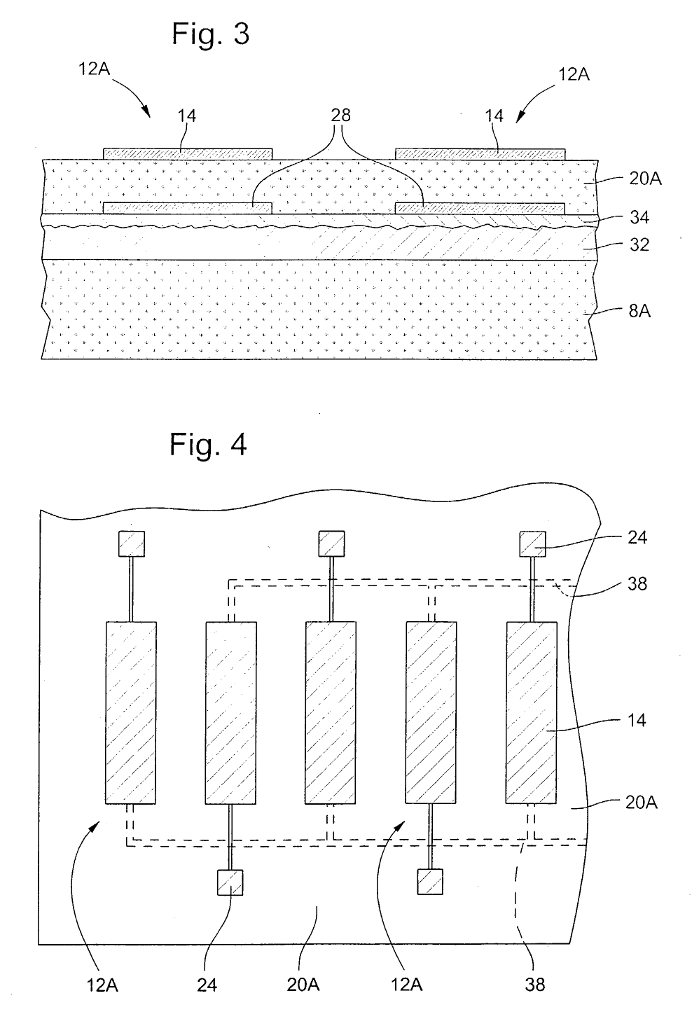

FIGS. 3 and 4 are respectively partial cross-section and top views of an embodiment of a sensor according to the invention.

The inventors have observed that lower electrode 18, common to all the pixels of sensor 2 shown in FIGS. 1 and 2, while of small thickness, generates non-negligible thermal cross-talk. In order to remove this drawback brought to light by their research, the inventors have improved the sensor described in FIGS. 1 and 2 by also structuring the lower electrode; i.e. by forming lower electrodes belonging to the pixels. Preferably, these lower electrodes do not have any metallic connection with the other lower electrodes of the sensor or they are connected to the latter only by metal paths that have a relatively small section and are preferably relatively long, as is the case of the sensor shown in FIG. 4, which will be described hereinafter. A “relatively small section” means a section considerably less than the section of the electrodes of a pixel along a perpendicular direction to the longitudinal direction defined by a row of pixels like that shown in FIGS. 2 and 4.

Within the scope of their research, the inventors deposited porous pyroelectric films for the purpose of reducing the electric permittivity of the pixels and thus increasing their efficiency. The results of this analysis are published particularly in the following two articles:

“High figure—of—merit porous Pb₁₋ₓCaₓTiO₃ thin films for pyroelectric applications”, A. Siefert & all, Applied Physics Letters, vol. 72, No 19, May 1998;

“Microstructural evolution of dense and pores pyroelectric Pb₁₋ₓCaₓTiO₃ thin films”, A. Seifert & all, Journal of Materials Research, vol. 14, No 5, May 1999.

The growth method described in these documents consists in a specific growth deposition of porous films. Such depositions are slow and thus relatively expensive. Further, they are limited to a restricted number of materials able to be deposited in this manner in porous form.

Thus, use of thin porous films for the pyroelectric film has proved particularly advantageous for the performance of the sensor thereby manufactured. Within the scope of the present invention, it was observed that such porous films have restricted thermal conductivity relative to previously deposited dense films. On the other hand, micromachining such films is a difficult operation given the difficulty of etching such porous films. Within the scope of research linked to porous pyroelectric films, the inventors have analysed the behaviour of a sensor like that shown in FIGS. 3 and 4, which has a continuous uniform porous pyroelectric film, i.e. that is not micromachined to obtain recesses as shown in FIG. 2. The results of the tests carried out showed that a sensor of this type has a high resolution level as regards the pixels, i.e. the thermal cross-talk between the pixels is relatively low. The level of this thermal cross-talk is kept at an entirely proper value when the lower and upper electrodes are structured.

The fact of providing an unstructured pyroelectric film for a sensor allows the cost price of the sensor to be reduced by removing manufacturing steps and in particular, the aforementioned step that is difficult to carry out. The sensor shown in FIGS. 3 and 4 is formed of a silicon substrate with no micromachined cavities or releases as previously described. On the upper surface of the substrate an aerogel film 32 is formed on which a planarization layer 34 is deposited given that the aerogel film has a certain roughness. Lower electrodes 28 are deposited on film 34. Next, the sensor includes a continuous porous pyroelectric film 20A, i.e. common to all the pixels and not micromachined between the pixels. Finally upper electrodes 14 are deposited on this film 20A. The embodiment of FIGS. 3 and 4 is particularly advantageous because it is essentially formed of continuous films that do not require any particular micromachining. Indeed, only the lower and upper electrodes with their conductive paths and the contact pads provided are structured and thus require micromachining by photolithography and conventional wet or dry etching steps. The aerogel film has the property of thermally insulating pixels 12A of substrate 8A. The use of such aerogel films is disclosed particularly in U.S. Pat. No. 5,949,071.

Upper electrodes 14 are connected to individual contact pads, which are arranged alternately on either side of the row of pixels. Upper electrodes 28 are connected to each other by means of conductive paths 38, shown in dashed lines in FIG. 4. These paths have a relatively small section and, given their arrangement, virtually no thermal cross-talk between the pixels.

Finally, within the scope of the research and development described here, the inventors used a much more advantageous deposition method for the porous pyroelectric film than that disclosed in the aforecited documents where the deposition is carried out by slow, expensive growth of the film, limited in the materials able to be used. This is how they devised the deposition of a porous pyroelectric film by liquid phase chemical deposition incorporating at least one polymer that is soluble in the stock solution. Such a deposition method described hereinafter, allows the cost price of the sensors to be greatly reduced. The liquid phase chemical deposition method used for application to pyroelectric sensors includes, in an alternative embodiment, the following steps:

Synthesis of a sol-gel solution with a base of alcoxides with a molarity of around 0.4;

Dissolution of di-hydroxy polyethylene oxide polymer in the alcoxide solution, particularly between 1.5 and 10% by weight unit;

Deposition of a film on the substrate and the lower electrodes from the alcoxide solution containing the polymer dissolved by spin-coating particularly at 3000 turns per minute for around 40 seconds;

First heat treatment at around 350° C. in order to decompose the organic content of the alcoxide solution and remove the polymer;

Second heat treatment between around 650° C. and 700° C. in order to transform the pyrolised alcoxide film in a pyroelectric ceramic material and to increase the porosity previously obtained by removing the polymer.

The last two steps can be repeated several times so as to obtain a thicker film. The molecular weight of the polymer dissolved in the stock solution is provided to be between 1000 and 4600 to obtain the desired porosity. By removing the polymer, the first heat treatment thus allows porosity to be obtained, which can be increased during the second heat treatment. The porosity per volume unit is situated between around 15 and 35%.

It will be noted that deposition onto the wafer being manufactured can be carried not only by centrifuging, but also by other techniques known to those skilled in the art, particularly by dip-coating, or by spray-coating. A porous pyroelectric film uniformly covering the substrate and the lower electrodes, at least in the region defined by the plurality of pixels forming the sensor according to the invention, is thus obtained.

On the basis of the teaching given here, those skilled in the art will be able to devise similar deposition methods using other stock solutions and other polymers to obtain an equivalent or similar result to that explained here.

1. Pyroelectric sensor including a plurality of pixels (12A; 12B) arranged on a substrate (4) and each formed of a thin pyroelectric film (20A), of a first electrode (14; 8A) of its own arranged on one face of said film and of a second electrode (28) of its own arranged on the other face, said second electrode having no metallic connection with the other second electrodes or being connected to the latter only by metallic paths of relatively small section, characterised in that said pyroelectric film is porous and continuous between pixels of the same sensor.

2. Sensor according to claim 1, characterised in that said pyroelectric film covers said substrate uniformly at least in the region defined by said plurality of pixels.

3. Sensor according to claim 1 or 2, characterised in that said substrate is not micromachined and has an intermediate film (32) with the pixels, formed of an aerogel forming thermal insulation between said pixels and the substrate.

4. Sensor according to claim 3, characterised in that said intermediate film is covered with a planarization layer.

5. Sensor according to any of claims 1 to 4, characterised in that said porous pyroelectric film is deposited by a sol-gel method with introduction of a polymer that is soluble in the stock solution, said polymer being removed after deposition of the film during at least one heat treatment.

6. Sensor according to claim 5, characterised in that said solution is an alcoxide solution and said polymer is di-hydroxy polyethylene oxide whose molecular weight is comprised between 1000 and 46000.

7. Sensor according to any of claims 1 to 6, characterised in that the volume of the pores by volume unit of the pyroelectric film is situated approximately between 15 and 35%.
